(19) United States
(12) Patent Application Publication
(10) Pub. No.: US 2005/0078747 A1
(43) Pub. Date: Apr. 14, 2005

(54) Multi-stage moving object segmentation

(75) Inventors: Rida M. Hamza, Eagan, MN (US); Kwong W. Au, Bloomington, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 10/684,865

(22) Filed: Oct. 14, 2003

(51) Int. Cl. H04N 7/12

(52) U.S. Cl. 375/240.01

(57) ABSTRACT

A method of detecting motion in a monitored area receives video or image frames of the area. A high-speed motion detection algorithm is used to remove still frames in that do not portray motion. The remaining frames are subjected to a robust high performance motion detection algorithm to detect true motion from noise. A resource management controller provides sequencing of the two stages, initialization and adaptive updates. The frames comprise pixels that are optionally grouped in blocks of variable-sized pixels, each block being represented as a set of single value and variance. A model of the area is initialized, and comprises multiple weighted distributions for each block of pixels. The model is updated differently depending on new frames matching or not matching the model. The matching is measured using a new simplified divergence measure based on Jefferey's approach.

### FIELD OF THE INVENTION

The present invention relates to moving object segmentation in a video sequence, and in particular to moving object segmentation utilizing multiple stages to reduce computational load.

### BACKGROUND OF THE INVENTION

Detection of events happening in a monitored area is very important to providing security of the area. Some typical areas include large open spaces like parking lots, plazas, airport terminals, crossroads, large industrial plant floors, airport gates and other outdoor and indoor areas. Humans can monitor an area, and easily determine events that might be important to security. Such events include human and vehicular traffic intrusions and departures from a fixed site. The events can be used in an analysis of traffic and human movement patterns that can be informative and valuable for security applications.

A variety of moving object segmentation techniques have been used to detect events in an area. For fixed/static cameras some techniques utilize: temporal differencing, background separation and adaptive background separation. Temporal differencing is adaptive to dynamic changes but usually fails to extract all the relevant objects, and can be easily confused by environmental nuances such as cast shadows, and ambient light changes.

Background separation provides more reliable solution than many temporal solutions, but is extremely sensitive to dynamic scene changes. A standard method of constructing an adaptive background for a dynamic scene is averaging the frames over time, creating a background approximation that is similar to the current static scene except where motion occurs. While this is effective in situations where objects move continuously and the background is visible a significant portion of the time, it is not robust to scenes with many moving objects particularly if they move slowly. It also cannot handle bimodal backgrounds, recovers the background slowly when it is uncovered, and has a single, predetermined threshold for the entire scene.

Changes in scene lighting can cause problems for the motion detection methods. One background method models each pixel with a Kalman Filter which makes the system more robust to lighting changes and cast shadows in a typical scene. While this method is based on a pixel-wise automatic thresholding for adaptation, it still recovers the background slowly and does not handle bimodal backgrounds well.

A further method includes implementation of a pixel-wise Expectation Maximization (EM) framework for detection of vehicles. The technical approach of this method attempts to explicitly classify the pixel values into three separate predefined distributions representing the background, foreground, and noise. Another more advanced moving object detection method is based on a mixture of normal representations at the pixel level. This mixture modeling method distributions reflects the expectation that more than one background characteristics at each pixel may be observed over time. This approach is well suited for outdoor applications with dynamic scenes.

Some previous approaches simply model the values of a particular pixel as a mixture of Gaussians. Based on the persistence and the variance of each of the Gaussians of the mixture, the approach determines which Gaussians correspond to background colors. Pixel values that do not fit the background distributions are considered foreground until their distributions are adapted into the scene and persistently became part of the background representation with sufficient, consistent evidence.

Following a similar approach a further method models each pixel in an image as a mixture of multiple tri-variate normal distributions. The method attempts to explicitly classify the pixel values into 5 weighted distributions, a few of which represent the background and the rest are associated with the foreground. The distributions are continuously updated to account for the dynamic change within the scene. Attempts to mediate the effect of changes in lighting conditions, and other environmental changes (e.g. snow, swaying tree leaves, rain, etc.) are successful, but it is all on the account of using more of the CPU capacity even for low resolution images and at slow frame rates. This computational burden has resulted in a limitation on the system use.

There is a need for a system that is robust and also fast and practical to implement for real-time operations. Robustness refers to detecting consistent true motion of an object while not generating false alarms on noisy movement and variations in illumination, weather, and environmental conditions. Fast processing refers to the capability of a processor to detect all motions in all frames for multiple input sequences.

### SUMMARY OF THE INVENTION

A method of detecting motion in a monitored area receives video or image frames of the area. A high speed motion detection algorithm is used to remove still frames in which a less than minimal amount of motion is portrayed. The remaining frames are subjected to a high performance motion detection algorithm to detect true motion from noise.

In one embodiment, each frame comprises pixel blocks that have one or more pixels, each block being represented as a single combinatory value (e.g. average or median pixel value) and a variance value. A model of the area is initialized, and comprises multiple weighted distributions for each pixel block. The model is updated differently depending on new frames matching or not matching the model.

A multi-stage process is used for motion segmentation. A first screening stage applies a fast video motion segmentation (VMS) to reject still images that do not portray any motion. A second stage, which is invoked when necessary, applies a robust VMS to detect the true motion of an object. Sequencing, initialization and adaptive updating of the stages is provided by a resource management controller.

In one embodiment, the fast VMS stage is based on intelligent sampling of video frames, operating in a single-pixel or multiple-pixel block mode, in an uncompressed- or compressed-image domain, and simplistic frame differencing approach.

Several approaches are selectively employed to reduce computational resource requirement for the second, robust VMS stage. Color separation is employed where appropriate. Grey pixels are sensitive in the RGB domain and are modeled separately. Since only luminance is required for representing a scene in grey, utilizing the grey model where it provides adequate detectability of motion reduces computational resource requirements.

A further approach employs non-uniform sampling. In other words, a scene may be divided into different areas whose pixels are grouped in different sizes depending on a desired resolution. Smaller pixel-block size areas or blocks are used for areas where motion likely occurs and higher resolution is desired. The number of pixels in a block may also be varied based on depth of field and range to target in order to maintain a consistent object size in pixel.

Adaptive mixture modeling is also provided based on operation environments. A fast technique adapts the number of normal distributions in the mixture modeling. The number of mixture is based on the amount of insignificant changes in the scene and how dynamic that change is. The technique coops well with multi-modal backgrounds (e.g. swaying tree branches, etc), whereas a single normal distribution may be used for stable scenes, especially for indoor applications.

Distributions of Sample Moments, similar to K-means, are used to initialize the models, rather than the cumbersome expectation maximization (EM). In one embodiment, a Look-Up-Table (LUT) registers the indices of frames' clusters for weight updates. Initial weights and distribution values are computed based on a predefined set of N frames. The set is clustered into subsets. Each subset represents the population of each distribution. The weights of each distribution is the ratio of the number of samples per subset over the predefined number of the initialization frames, i.e. N. In contrast to EM approximation, the approach provides more accurate initial statistical support that facilitates fast convergence and more stable performance of the segmentation operations.

A FIFO (first in, first out) procedure is used to update the mixing proportions weights of the mixture models with no thresholds or learning parameters. Weights are updated based on the new counts of samples per each distribution. The first frame entered in the LUT will be excluded out of the record to update the weights of each classes of distributions. When a match is found, the non-matching distribution (representing foreground) counter is set to zero. The LUT is updated by excluding the first index and including the new record. The weights are updated based on the new variation in the subsets. If there is no match, the foreground distribution counter is incremented. Weights of background distributions are kept the same. The smallest distribution is replaced, once an adequate number of consecutive hits of the foreseen foreground is reached. During the replacement of the smallest distribution with the new foreground distribution adapting to be part of the new background, no weights will be updated. Updates will follow afterwards using the above role.

These approaches reduce computational requirements to make the approach well suited to real-time applications.

### BRIEF DESCRIPTION OF THE DRAWINGS

FIG. 1 is a block diagram of an example moving object segmentation system.

FIG. 2 is a diagram of an example sampling method used in the moving object segmentation system of FIG. 1.

FIG. 3 is a block diagram illustrating block element selection for an example high speed moving object segmentation subsystem of FIG. 1.

FIGS. 4A, 4B and 4C are representations of various modeling approaches showing different numbers of normal distributions.

FIG. 5 illustrates updating mixing proportions weights in a mixture model.

FIG. 6 is a block diagram of a typical computer system for executing software implementing at least portions of the moving object segmentation system.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

A multi-stage process is used for motion segmentation. A first screening stage applies a fast video motion segmentation (VMS) to reject still images that do not portray any motion. A second stage, which is invoked when necessary, applies a robust VMS to detect the true motion of an object.

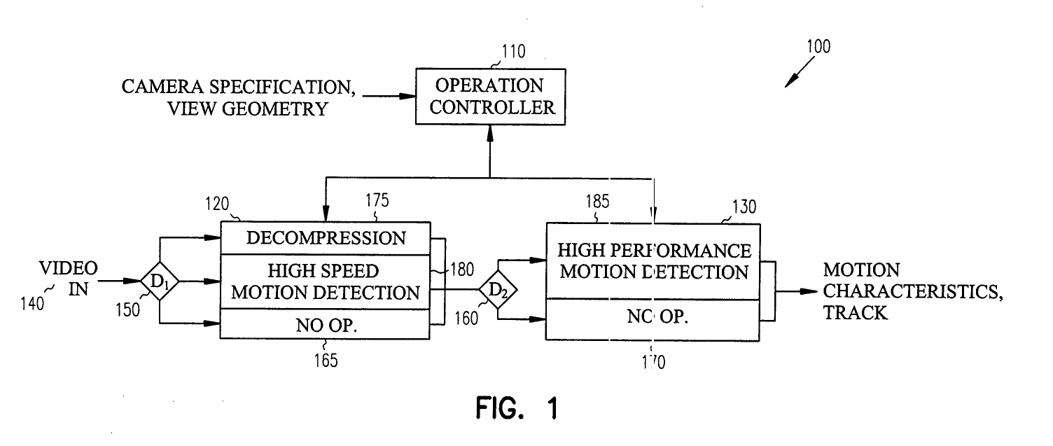

In one example of the invention, three modules work synergistically to provide the optimal functional and computational performances in detecting motion in a video sequence as indicated at 100 in FIG. 1. The three modules are an operation controller (OC) 110, a high speed motion detection (HSMD) module 120, and a high performance motion detection (HPMD) module 130. OC 110 is a resource management unit that essentially sets operational parameters for the modules and guides operational flow. HSMD 120 is a screening unit that receives video from a scene at 140 and quickly removes the motionless video frames. HPMD 130 is a robust unit that detects true object motion and weeds out other noisy annoyances. It receives video frames that are passed to it by HSMD 120.

Operation Controller: Operation Controller (OC) module 110 serves as a resource management unit that maintains the frame rate and functional performance via setting the processing-speed-related parameters. To maintain the frame rate, some video frames will be skipped and not processed. The OC computes a maximum allowable number of frames to be skipped based on the speed of the expected objects, the camera frame rate and the physical area coverage within the field of view (FOV). When the actual processing frame rate falls behind the desirable rate, the OC skips processing up to the maximum allowable number of frames. This is achieved by setting the D₁ and D₂ decision blocks 150 and 160 respectively to “No Op.” as represented at 165 and 170 in the motion detection modules.

The operation controller also directs the operation flow which consists of initialization and motion detection. Executing the alternative operation flow achieves overall high speed, high performance motion detection and tracking.

Initialization:

The operation controller 110 directs an initialization process for the HSMD and the HPMD during the startup. Another condition to execute the HSMD and the HPMD initialization processes is when the video camera carries out a pan and tilt operation. The OC calls the HSMD initialization when the HPMD completes a motion detection sequence. In addition, the OC also calls the HSMD initialization, when a different HSMD function is selected.

Motion Detection Operation Flow:

The OC sets the conditions in the D₁ 150 and D₂ 160 decision blocks, which directs the input and output data to the appropriate processing modules. The D₁ decision block directs the input video frame to a decompression module 175, HSMD sub-module 180, or the No Op module 165. The D₂ decision block directs the output video frame from stage one to a HPMD sub-module 185 or the No Op module 170. The rules in setting the D₁ and D₂ blocks are:
HSMD is selected after initialization startup.
When the HSMD module detects motion, HPMD is selected.
The HPMD module requires periodical updates. When the update time is reached, the HPMD module will be selected.
When the HSMD module does not detect motion and the HPMD module doe not need update, the No Op module in the second stage will be selected.
When the HPMD module detects motion in the (n−1)^{th} frame, Decompression module will be selected in the n^{th} frame if the video in 140 is compressed.
When the decompression module is selected, the HPMD module will also be selected.
When a skip frame decision is made, both No Op modules will be selected.
   Function Selection in HSMD Module:

Several functions can be applied in the HSMD module. Each function achieves different functional and computational performances. OC selects the proper function based on the desirable frame rate, the object whose motion is of interest, and the scene complexity.

Parameter Setting in the HSMD and HPMD Modules:

OC computes the values of critical functional and computational parameters in the HSMD and HPMD modules. Some of the parameters include the video frame boundary, the number of DCF coefficients to compute HSMD motion detection, and subsample pattern.

The frame size often is so large that number of computations on all pixels is astronomical. Subsamples of the video frame are necessary to maintain the desirable processing frame rate. A uniform sample in both the row and column dimensions is frequently used. Some approaches apply different sample rates in the row and column dimensions. The sample rate, however, is uniform across each direction. In one embodiment, the sampling approach, as illustrated in FIG. 2, is one that is based on constant object resolution in the image domain. The key is to keep the object size in the image domain approximately the same no matter whether the object is in the near side or far side of the field of view (FOV). As seen in FIG. 2, sample locations 210 further away from a camera 220 are more closely spaced than sample locations 230 that are closer to camera 220.

High Speed Motion Detection:

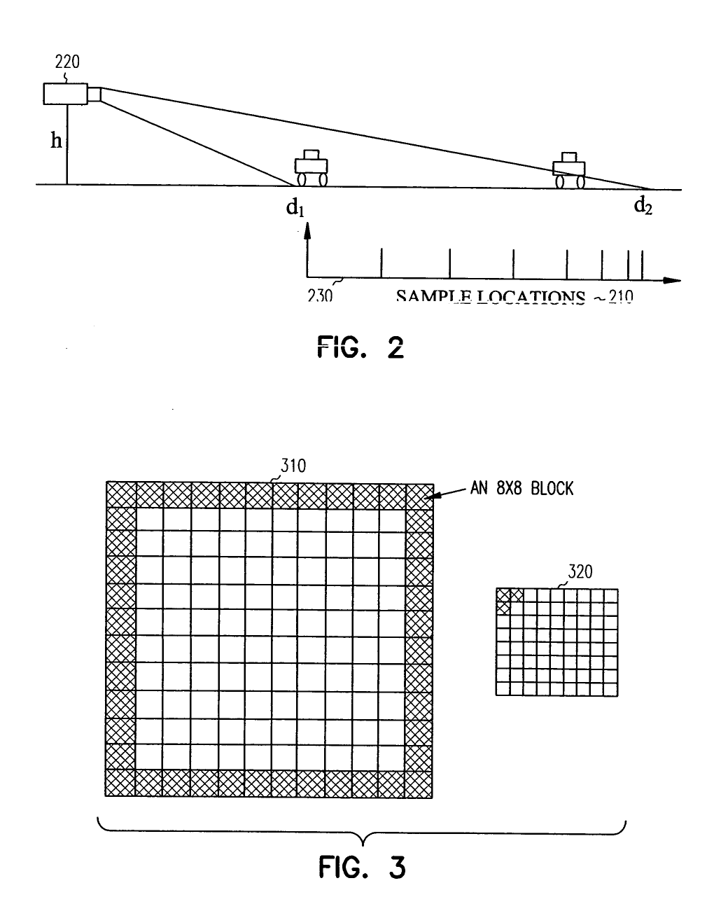

The high speed motion detection module 120 achieves the high speed performance via a combination of two approaches. The first approach is to detect motion in the transformed domain when the input video frame is compressed. This approach avoids the intense, inverse transform computation, e.g., the inverse DCF in the JPEG video stream. In addition, in some embodiments, detections along the boundaries of the FOV are limited, assuming that the camera 220 is mounted on a fixed site and that the motion enters into the FOV across its boundaries first. This approach can be applied to compressed or non-compressed video frames. FIG. 3 at 310 illustrates the elements selected for motion detection processing. The number of boundary layers and number of elements in each block 320 are determined by the operation controller 110 based on the object size, and the video frame size.

High Performance Motion Detection:

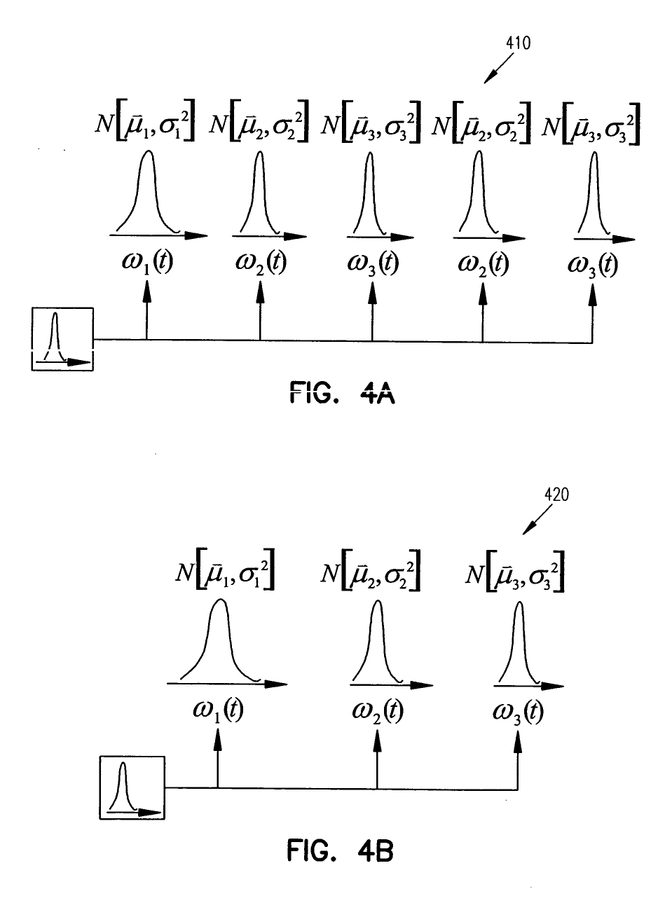

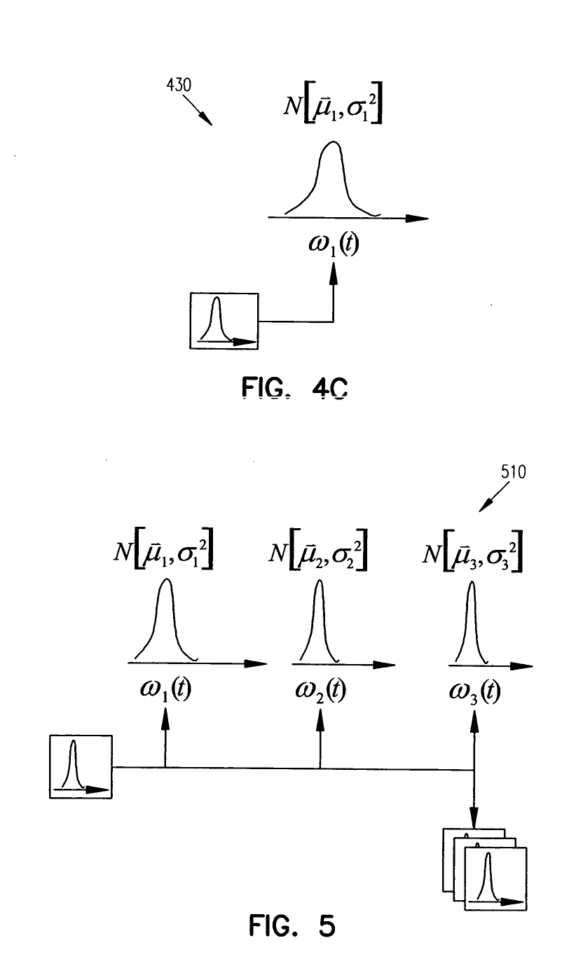

Distributions of sample moments shown at 410 in FIG. 4A, are used to initialize models that model an area to be monitored. An adaptive mixture model is configured based on operation environments. In one embodiment, N, such as approximately 70 to 100 or more consecutive images are processed to initialize a model. Five normalized distributions that provide the strongest evidence are selected to model a background in a monitored area. The number of distributions is varied in one embodiment based on the amount of insignificant changes in a scene, and how dynamic the change is. Three distributions 420 are illustrated in FIG. 4B for moderate scene changes, and a single distribution is shown for single modeling at 430 in FIG. 4C. This model is useful for stable scenes, such as indoor applications. The model with the higher number of distributions is used to deal robustly with lighting changes, dynamic scene motions, tracking through cluttered regions and coping well with insignificant slow-moving objects in a nominal open space (e.g. swaying tree branches, drops of snow or rain, dropped leaves due to winds, ambient light changes due to car headlights, etc. The model for the background distribution is maintained even if it is temporarily replaced by another distribution which leads to faster recovery when objects are removed.

The approach provides more accurate initial statistical support that facilitates fast convergence and more stable performance of the segmentation operations. An improved divergence measure is used as the matching criterion between normal distributions of incoming pixels/blocks and existing pixel or blocks model distributions. A modified Jefferey's divergence measure is an accurate and simplified measure to the fixed values (constant incoming variance) as illustrated below.

Modified Jeffrey's Divergence Measure:

A modified measure is based upon the Jeffrey's divergence to measure similarity and divergence among distributions. The procedure is similar to the earlier approaches where the algorithm checks if the incoming pixel/ROI value can be ascribed to any of the existing normal distributions. The matching criterion used is referred to as modified Jeffrey's divergence measure.

While Jeffrey's divergence measure (J) H. Jeffreys, “Theory of Probability,” Universal Press, Oxford, 1948, is used, unlike earlier work, the measure is reformulated to fit the application in hand. Thus, a much simpler formulation of Jeffrey's measure used is manageable to be computed in real time while preserving the accuracy and integrity of Jeffrey's formula.

Jeffrey's measure of information associated with the probability distribution of g and fᵢ (where fᵢ˜N₃(\vec{μ}ᵢ,σᵢ²I) and g˜N₃(\vec{μ}_{g},σ_{g}²I) is given by

$$J ( Fi , g ) = \frac{3}{2} {( \frac{{σ}_{i}}{{σ}_{g}} - \frac{{σ}_{g}}{{σ}_{i}} )}^{2} + \frac{1}{2} ( \frac{1}{{σ}_{i}^{2}} + \frac{1}{{σ}_{g}^{2}} ) {( \vec{{μ}_{g}} - \vec{{μ}_{g}} )}^{T} ( \vec{{μ}_{g}} - \vec{{μ}_{i}} ) \qquad ( I )$$

J(fᵢ,g) is the symmetric measure of directed divergence as shown in (MPT)V. Morallas, Y. Pavlidas, et al, “DETER: Detection of Events for Threat Evaluation and Recognition,” 1999. Since the J(fᵢ,g) measure relates to distributions and not to data points, the incoming pixels data points are modeled with a fixed, predefined distribution regardless of the application and conditions. In fact, the incoming distribution g˜N₃(\vec{μ}_{g}, σ_{g}²I) is assumed to have \vec{μ}_{g}=\vec{x}(t); σ_{g}²=const. The choice of the constant variance was based on some experimental observations. σ_{g}² may not be predefined as it varies with the operating environments. Better estimates of the incoming distribution are dependent upon the current operations and not predefined constants. While this approximation is framed to simplify the divergence measure, estimates of the incoming distribution yield a much compact form of divergence measure. This simplified formulation is referred to as a modified Jeffrey's measure. The new measure is equivalent to the original Jeffrey's measure.

To model the incoming dist., g, two assumptions are introduced to simplify the formulations:
[symbol] μ_{g}=x(t); The mean vector of the incoming dist is set to be equivalent to the incoming measurement. This is similar to the earlier approach.
[symbol] The variance depends upon the current distribution variance, our hypothesis, i.e. σ_{g}² is a scalar of σᵢ², or σ_{g}²=αᵢσ² where αᵢ is a dependency scalar.

Thus eq (I) can be rewritten as follows:

$$J ( {f}_{i} , g ) = \frac{3}{2} {( {α}_{i} - \frac{1}{{α}_{i}} )}^{2} + \frac{1}{2 {σ}_{i}^{2}} ( 1 + \frac{1}{{α}_{i}^{2}} ) {( \vec{{μ}_{g}} - \vec{{μ}_{i}} )}^{T} ( \vec{{μ}_{g}} - \vec{{μ}_{i}} ) \qquad ( II )$$

To have an equal-likelihood estimate, assume αᵢ=α (i.g. similar factor across all distributions) for simplicity without loss of generalization. Hence, the first term becomes

[symbol]

$$1 st term = \frac{3}{2} {( α - \frac{1}{α} )}^{2} = const ,$$

as an additive constant and can be dropped from measurement.

[symbol]

$$In 2 nd term , \frac{1}{2} ( 1 + \frac{1}{{α}^{2}} ) = δ ,$$

Thus the term becomes a scalar factor and can be also excluded from measure.
Hence the new measure is

$$\tilde{J} ( {f}_{i} , g ) = \frac{1}{{σ}_{i}^{2}} {( \vec{{μ}_{g}} - \vec{{μ}_{i}} )}^{T} ( \vec{{μ}_{g}} - \vec{{μ}_{i}} ) \qquad ( III )$$

Equation (III) presents the new Modified Jeffery's divergence measure, which is greatly simplified. The divergence measure is an unbiased estimate as shown in the counter example below.

Counter Example:

The estimate of incoming pixel dist yields an unbiased measure. For instance, assuming no change in the scene, the incoming dist will be identical to one of the predefined distributions, fₒ˜N₃(\vec{μ}ₒ, σₒ²I). Thus:

$$\tilde{J} ( {f}_{o} , g ) = \frac{1}{{σ}_{0}^{2}} {( \vec{{μ}_{g}} - \vec{{μ}_{o}} )}^{T} ( \vec{{μ}_{g}} - \vec{{μ}_{o}} ) = 0 ,$$

and \tilde{J}(fᵢ,g)≠0; ∀i≠o; i.e. this is consistent with the hypothesis.

The measure defined in [PM], however, yields to the wrong measurement when using a predefined σ_{g} (e.g. σ_{g}=25). This results into a non-zero divergence measure,

$$J ( {f}_{o} , g ) = \frac{3}{2} {( \frac{{σ}_{i}}{25} - \frac{25}{{σ}_{i}} )}^{2} \neq 0$$

Which contradicts the hypothesis.

For illustration purposes, we assumed a block of pixels is represented by a three-distribution model as shown in FIG. 5 at 510. The three distributions are selected as the highest probability distributions from the initial model. The distributions are normalized by providing weights that add to one. The weights are based on a count of the sample. When a match is found, such as when no motion is detected and the new image matches the model, the weights are updated using adaptive weights based on FIFO methods. Both weights and variances are updated. The most recent sample, N, is used to determine the new weights. N may be 100, as in one embodiment of the model initialization, or another number as desired. Distribution is updated by including the incoming block/pixel into the new statistics.

When a match is not found the update is performed only after a number of hits (i.e. consequent non-matches with the same incoming distribution) is reached. The minimum required number of hits in one embodiment is equal to N times the weight of the smallest wᵢ(t). Once the minimum number of hits is reached, the update is performed in a way that guarantees the inclusion of the incoming distribution by using it to replace the lowest weighted current distribution.

The method described above allows identification of foreground pixels or ROI in each processed frame. The method is implemented to run in the pixel domain as well as in the compression domain.

Motion Detection Enhancements:

The speed motion detection algorithm represents portions of images in grey scale pixels when such portions are not high in color content, or are not expected to have motion. These areas may be selected on initialization based on knowledge of an operator, or may be selected based on a real time assessment of the scene. Portions of images are represented with color pixels, RGB for portions of the images higher in color content or those that are expected to have higher probability of motion. The portions for representing in grey scale and color may also be determined based on a real time assessment of dynamic change in the area.

In one embodiment, frames comprise pixels that are grouped in blocks of pixels, each block being represented as a single average pixel. The distributions and other statistics may be based on an average pixel for each block. In further embodiments, the blocks of pixels are of different sizes. Portions of the scene or area requiring higher resolution to detect motion are represented by smaller blocks of pixels, while those requiring lower resolution may be represented by larger blocks of pixels. In one embodiment, the size of the blocks is varied based on depth of field. In still further embodiment, the number of values per pixel is varied between 1 and 5, and may be varied based on dynamics of motions or expectations.

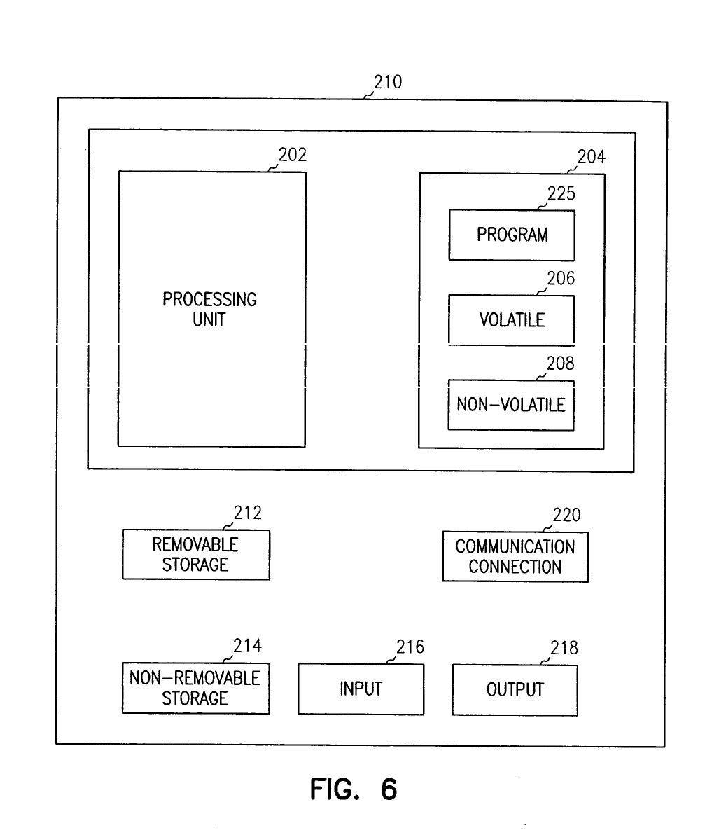

A block diagram of a computer system that executes programming for performing the above algorithm is shown in FIG. 6. A general computing device in the form of a computer 610, may include a processing unit 602, memory 604, removable storage 612, and non-removable storage 614. Memory 604 may include volatile memory 606 and non-volatile memory 608. Computer 610 may include—or have access to a computing environment that includes—a variety of computer-readable media, such as volatile memory 606 and non-volatile memory 608, removable storage 612 and non-removable storage 614. Computer storage includes RAM, ROM, EPROM & EEPROM, flash memory or other memory technologies, CD ROM, Digital Versatile Disks (DVD) or other optical disk storage, magnetic cassettes, magnetic tape, magnetic disk storage or other magnetic storage devices, or any other medium capable of storing computer-readable instructions. Computer 610 may include or have access to a computing environment includes input 616, output 618, and a communication connection 620. The computer may operate in a networked environment using a communication connection to connect to one or more remote computers. The remote computer may include a personal computer, server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 602 of the computer 610. A hard drive, CD-ROM, and RAM are some examples of articles including a computer-readable medium. For example, a computer program 625 capable of providing a generic technique to perform access control check for data access and/or for doing an operation on one of the servers in a COM based system according to the teachings of the present invention may be included on a CD-ROM and loaded from the CD-ROM to a hard drive. The computer-readable instructions allow computer system 600 to provide generic access controls in a COM based computer network system having multiple users and servers.

### Conclusion

A real-time segmentation method of moving objects is used to monitor their movements in large open spaces like parking lots, plazas, airport terminals, crossroads, large industrial plant floor, airport perimeter and gates, and other outdoor and indoor applications. Of particular interest is monitoring human and vehicular traffic intrusions and departures from a fixed scene. The method and devices are applied as the engine for detecting motions and tracking of traffics to analyze traffic and human movement patterns. These patterns can be informative and valuable for a security application.

The method is also useful in homeland security applications where human or vehicle traffic is monitored to investigate events, increase situational awareness of all activities, learn about an abnormal and suspicious events, and detect a threat before its occurrence.

Abandoned objects may be detected and traced back to whom they belong and how they have been introduced into the scene. Collection of traffic statistics around a commercial or government buildings are also valuable for security reasons and marketing reasons, or to support a functional redesign of the open space for better safety needs and traffic management.

The method is based on two advanced object motion detection stages. The fast segmentation stage applies intelligent sampling, and differencing techniques in compressed or uncompressed image domains The robust segmentation stage adopts a statistical mixture modeling approach and provides changes that improve the computational and functional performances of this stage. In addition, some embodiments of the method are suited to real-time, e.g. full frame rates at high spatial resolutions, applications. A resource management controller determines the sequencing, initialization and adaptive updates.

1. A method of detecting motion in an area, the method comprising:
receiving frames of the area;
using a high speed motion detection algorithm to remove frames in which a threshold amount of motion is not detected; and
using a high performance motion detection algorithm on remaining frames to detect true motion from noise.

2. The method of claim 1 wherein the high speed detection algorithm operates in a compressed image domain.

3. The method of claim 1 wherein the high speed detection algorithm operates in an uncompressed image domain.

4. The method of claim 1 wherein the high performance detection algorithm operates in an image pixel domain.

5. The method of claim 4 wherein the high speed motion detection algorithm represents portions of images in grey scale pixels.

6. The method of claim 5 wherein portions of the image are represented in grey scale when such portions are not high in color content.

7. The method of claim 1 wherein the high performance detection algorithm operates on frames having pixels in grey scale for portions of the images low in color content, and having pixels in RGB or other color domain for portions of the images higher in color content.

8. The method of claim 7 wherein the portions are based on an initial set up.

9. The method of claim 1 wherein the high performance detection algorithm operates on frames having pixels in grey scale for selected portions of the images, and having pixels in RGB or other color domain for other portions of the images, wherein the portions are determined based on a real time assessment of dynamic change in the area.

10. The method of claim 1 wherein the threshold is predetermined.

11. The method of claim 1 wherein the area is a predetermined area.

12. The method of claim 1 wherein the frames comprise pixels, and where such pixels are grouped in blocks of pixels, each block being represented as a single (i.e. average or median) unit in the color domain.

13. The method of claim 12 wherein the blocks of pixels are of different sizes.

14. The method of claim 13 wherein portions of the area requiring higher resolution to detect motion are represented by blocks of smaller number of pixels.

15. The method of claim 13 wherein the number of pixels in the blocks is varied based on depth of field.

16. A method of detecting motion in an area, the method comprising:
receiving frames of the area;
using a high speed motion detection algorithm to remove frames in which a threshold amount of motion is not detected;
using a high performance motion detection algorithm on remaining frames to detect true motion from noise, wherein the frames comprise pixels, and where such pixels are grouped in blocks of pixels, each block being represented as a single average pixel; and
initializing a model of the area comprising multiple weighted distributions for each block of pixels.

17. The method of claim 16 wherein the frames comprise blocks of pixels, and wherein a number of weighted distributions per block is varied.

18. The method of claim 17 wherein the number of weighted distributions varies between 1 and 5.

19. The method of claim 17 wherein the number of weighted distributions is varied based on dynamics of motions or expectations.

20. The method of claim 16 wherein the model is based on N successive frames and the weight is based on a count.

21. The method of claim 16 wherein a predefined number of weighted distributions is selected for each block of pixels, and wherein the weights are normalized.

22. The method of claim 16 wherein if pixels in a new frame match the model, the model weights and distributions are updated.

23. The method of claim 16 wherein a divergence measure (modified Jeffery's measure as defined above) is used to determine a match or non-match in the distributions.

24. The method of claim 16 wherein if a predetermined number of frames have pixels or blocks that do not match the model, the lowest weighted distributions of the pixels or blocks of a background are removed from the model and replaced by ones derived from a foreground distribution once a derived number of sequences is reached within the last N successive frames.

25. The method of claim 16 wherein the high speed motion detection algorithm operates in a compressed image domain.

26. The method of claim 16 wherein the high speed motion detection algorithm operates in an uncompressed image domain.

27. A system for detecting motion in a monitored area, the system comprising:
means for receiving video images of the monitored area;
a fast video motion segmentation (VMS) module that rejects still images that do not portray any motion;
a robust VMS module that detects motion of an object in the monitored area; and
a resource management controller that initializes, controls, and adapts the fast and robust VMS modules.
